(19) United States
(12) Patent Application Publication
(10) Pub. No.: US 2007/0013094 A1
(43) Pub. Date: Jan. 18, 2007

(54) Method for the preparation of porous, carbon-based material

(76) Inventors: Norman Bischofsberger, Guntersblum (DE); Andreas Ban, Darmstadt (DE); Bernhard Mayer, Mainz (DE); Dov Goldmann, Wiesbaden (DE); Jorg Rathenow, Eppstein (DE); Soheil Asgari, Wiesbaden (DE)

Correspondence Address: FROMMER LAWRENCE & HAUG, 745 FIFTH AVENUE- 10TH FL., NEW YORK, NY, 10151, US

(21) Appl. No.: 11/273,644

(22) Filed: Nov. 14, 2005

Related U.S. Application Data
(63) Continuation-in-part of application No. PCT/EP04/05277, filed on May 17, 2004.

(30) Foreign Application Priority Data
May 16, 2003 (DE) 103 22 182.4

(51) Int. Cl. C01B 31/02

(52) U.S. Cl. 264/29.6

(57) ABSTRACT

The invention relates to a method for the preparation of porous carbon-based material comprising the steps provision of a polymer film provided in the form of a sheet or a coating; as well as pyrolysis and/or carbonization of the polymer film in an atmosphere that is essentially free of oxygen at temperatures in the range of 80° C. to 3,500° C. The invention further relates to carbon-based material producible according to the method mentioned above.

### INCORPORATION BY REFERENCE

This application is a continuation-in-part application of international patent application Serial No. PCT/EP2004/005277 filed May 17, 2004, which claims benefit of German patent application Serial No. DE 103 22 182.4 filed May 16, 2003.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

### FIELD OF THE INVENTION

The present invention relates to a method for the preparation of porous, carbon-based material by pyrolysis and/or carbonization of polymer films that are in the form of sheets or coatings in an atmosphere that is essentially free of oxygen at temperatures in the range of 80° C. to 3,500° C.

### BACKGROUND OF THE INVENTION

Porous, carbon-based materials have been used in the area of fluid separation for quite some time. Such materials may be prepared and used in suitable form as adsorbents, membrane layers, or self-supporting membranes. The various possibilities to specifically change both the porosity and the chemical properties of carbon-based materials make these materials especially interesting, for example, for selective fluid separation tasks.

A series of methods for the preparation of porous carbon-based materials that are in two-dimensional form, in particular in sheet form, are described in other publications. In WO 02/32558 for example is described a method for the preparation of flexible and porous adsorbents on the basis of carbon comprising materials, wherein a two-dimensional base matrix, the components of which are essentially held together by hydrogen bonds, is prepared on a paper machine and subsequently pyrolyzed. The starting materials used in this International Application are essentially fibrous substances of various kinds, since these are usually used on paper machines and the individual fibers in the prepared paper are then essentially held together by hydrogen bonds.

Similar methods are described for example in Japanese Patent Application JP 5194056 A, as well as in the Japanese Patent Application JP 61012918. In these documents, papermaking processes are also described, whereby sheets of paper are manufactured from organic fibers or plastic fibers as well as pulp that are treated with phenol resin and subsequently dried, hot pressed, and carbonated in an inert gas atmosphere. In this manner, thick, porous carbon sheets with resistance against chemicals and electrical conductivity may be obtained.

However, a disadvantage of the methods described above is that the fiber materials used in the starting material largely predetermine the density and also the porosity of the resulting carbon material after pyrolysis, depending upon their fiber thickness and fiber length as well as their distribution in the sheet-like paper material. Pores with oversized dimensions require additional complex aftertreatment steps such as chemical vapor phase infiltration in order to narrow the pores by deposition of additional carbon material.

Furthermore, according to the methods cited above, only starting materials that are usable in a necessarily aqueous paper processing process may be used, which severely limits the selection of the possible starting materials, and may exclude the use of hydrophobic plastics. Hydrophobic plastics such as polyolefins are often preferred starting materials over natural fibers due to their relatively high carbon content and their easy availability in consistent quality.

Therefore, there is a need for a cost-effective and simple method for the preparation of porous carbon-based materials that does not require the use of paper-like materials prepared from fibers.

Citation or identification of any document in this application is not an admission that such document is available as prior art to the present invention.

### SUMMARY OF THE INVENTION

It is therefore one object of the present invention to provide a method for the preparation of porous, essentially carbon-based materials that allows for the preparation of such materials having widely-variable properties from inexpensive starting materials in a cost effective manner and with few process steps.

A further object of the present invention relates to the provision of a method for the preparation of porous carbon-based materials that allows for the preparation of stable self-supporting structures or membranes or membrane layers from porous carbon-based material.

A solution according to the invention of the objects stated above includes a method for the preparation of porous, carbon-based material that comprises the following steps:
a) provision of a polymer film that may be in e form of a sheet or a coating;
b) pyrolysis and/or carbonization of the polymer film in an atmosphere that is essentially free of oxygen at temperatures in the range of 80° C. to 3,500° C.

In an embodiment of the present invention, the pyrolysis and/or carbonization of the polymer film is carried out in an atmosphere that is essentially free of oxygen at temperatures in the range of 200° C. to 2,500° C.

It is noted that in this disclosure and particularly in the claims and/or paragraphs, terms such as “comprises,” “comprised,” “comprising” and the like can have the meaning attributed to it in U.S. patent law; e.g., they can mean “includes,” “included,” “including,” and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### DETAILED DESCRIPTION

According to the invention, it was found that carbon materials may be made by pyrolysis and/or carbonization of polymer films at high temperatures, where the films may comprise both sheets of suitable polymer materials and coatings, the porosity of which may be specifically adjusted in wide ranges depending upon the polymer film material that was used, its thickness and structure.

Polymer films have the advantage that they are easily prepared or commercially available in almost any dimension. Polymer films are easily available and cost-effective. In contrast to the use of paper as starting material for the pyrolysis and/or carbonization, polymer films, particularly sheets and coatings such as for example lacquers, have the advantage that hydrophobic materials—which usually cannot be used with the pulps or water-compatible natural fibers used in papermaking—may be used for the preparation of carbon-based materials.

Polymer films are easily formable and may be processed to form larger ensembles and structures prior to pyrolysis or carbonization, such structures essentially being maintained during pyrolysis/carbonization of the polymer film material. In this manner, it is possible by multiple layering of polymer films to form film or sheet packages and subsequently subject them to pyrolysis and/or carbonization according to the method of the present invention. This process may be used to generate package or modular structures from porous carbon-based material that—due to the mechanical strength of the resulting material—may be used as self-supporting, mechanically stable membrane or adsorber packages in fluid separation.

Prior to pyrolysis and/or carbonization, the polymer films may be structured in a suitable manner by folding, stamping, die-cutting, printing, extruding, spraying, injection molding, gathering and the like, and may optionally be bonded to one another. For bonding, conventional known adhesives and other suitable adhesive materials may be used, including but not limited to: water glass, starch, acrylates, cyanoacrylates, hot melt adhesives, rubber, or solvent-containing as well as solvent-free adhesives. The method according to the invention allows for the preparation of specifically constructed three-dimensional structures with ordered build-up from the desired porous carbon-based material.

In forming such structures (e.g. for use as membrane packages), the carbon-based material does not have to be prepared first and then formed into the desired three-dimensional structure by complex forming steps. The method according to the invention allows for formation of the finished structure of the carbon-based material by suitable structuring or forming of the polymer film prior to the pyrolysis and/or carbonization.

Consequently, by the method according to the invention, finely-spaced structures may also be created that would be difficult or impossible to create by subsequent forming of finished carbon material. In this connection, for example the shrinkage usually occurring during pyrolysis and/or carbonization may be specifically used to create finer features in the final structure.

The polymer films that are usable according to the invention may be provided two-dimensionally in sheet or web form, e.g. as rolls of material, or also in tube form or in a tubular or capillary geometry. Polymer films in form of sheets or capillaries may be prepared, for example, by means of phase inversion methods (asymmetrical layer build-up) from polymer emulsions or suspensions.

Suitable polymer films that may be used in the method of the present invention may include sheets, tubes, or capillaries from plastics. Preferred plastics include but are not limited to: homo- or copolymers of aliphatic or aromatisc polyolefins, such as polyethylene, polypropylene, polybutene, polyisobutene, polypentene; polybutadiene; polyvinyls such as polyvinyl chloride or polyvinyl alcohol, poly(meth)acrylic acid, polyacrylonitrile, polyacrylocyanoacrylate; polyamide; polyester, polyurethane, polystyrene, polytetrafluoroethylene; polymers such as collagen, albumin, gelatin, hyaluronic acid, starch, celluloses such as methylcellulose, hydroxypropylcellulose, hydroxypropylmethylcellulose, carboxymethylcellulose phtalat; waxes, paraffin waxes, Fischer-Tropsch-waxes; casein, dextranes, polysaccharides, fibrinogen, poly(D,L-lactides), poly(D,L-lactides-co-glycolides), polyglycolides, polyhydroxybutylates, polyalkylcarbonates, polyorthoesters, polyhydroxyvaleric acid, polydioxanones, polyethylene terephthalate, polymalatic acid, polytartronic acid, polyanhydrides, polyphosphazenes, polyaminoacids; polyethylene vinylacetate, silicones; poly(ester-urethanes), poly(ether-urethanes), poly(ester-ureas), polyethers such as polyethylene oxide, polypropylene oxide, pluronics, polytetramethylene glycol; polyvinyl pyrrolidone, poly(vinyl acetate phatalate), mixtures of homo- or copolymers of one or more of the aforementioned materials, as well as additional polymer materials known to those skilled in the art that may also be typically processed to films, tubes or capillaries.

Other kinds of polymer films that may be used in the present invention include polymer foam systems, including but not limited to: phenol foams, polyolefin foams, polystyrene foams, polyurethane foams, and fluoropolymer foams. Such foams may be converted into porous carbon materials in a subsequent carbonization or pyrolysis step according to the invention. Use of such foams has the advantage that the pore structure resulting from the carbonization step may be adjustable based upon the initial foam porosity. For the preparation of the foamed polymers, any conventional foaming methods may be used, using known blowing agents including but not limited to halogenated hydrocarbons, carbon dioxide, nitrogen, hydrogen and low-boiling hydrocarbons. Fillers that are suitable to cause foam formation in or on the polymer film may also be applied into or onto the polymer films.

Furthermore, in the method according to the invention, the polymer film may be a coating, such as a lacquer film, that was produced from a lacquer with a binder base of alkyd resin, chlorinated rubber, epoxy resin, formaldehyde resin, (meth)acrylate resin, phenol resin, alkylphenol resin, amine resin, melamine resin, oil base, nitro base (cellulose nitrate), polyester, polyurethane, colophony, Novolac®—epoxy resins, vinylester resin, tar or tar-like substances such as tar pitch, bitumen, as well as starch, cellulose, shellac, waxes, modified binders of the aforementioned substances, or binders of organic renewable raw materials, or combinations of the aforementioned substances. Preferred materials include lacquers based on phenol and/or melamine resins that may optionally be fully or partially epoxidized, e.g. commercial packing lacquers such as one- or two-component lacquers based on optionally epoxidized aromatic hydrocarbon resins.

Coatings that may be used according to the invention may be applied to a suitable carrier material from the liquid, pulpy, or paste-like state. Application of such coatings may be performed by, for example, coating, painting, lacquering, phase inversion, atomizing, dispersion or hot-melt coating, extruding, casting, dipping, or as hot melts from the solid state by means of powder coating, flame spraying, sintering or the like according to known methods. The lamination of carrier materials with suitable polymers is also a method that is usable according to the invention to provide a polymer film in the form of a coating.

The use of coatings in the method according to the invention may for example occur in such a way that a coating is applied to an inert carrier material, optionally dried, and subsequently subjected to pyrolysis and/or carbonization, the carrier material being essentially completely pyrolyzed or carbonized through suitable selection of the pyrolysis or carbonization conditions, so that the coating such as for example a lacquer remains after pyrolysis or carbonization in form of a porous carbon-based material. In the method according to the invention, the use of coatings, particularly of lacquers, finishes, laminates and the like allows for the preparation of especially thin carbon-based materials in sheet form.

Polymer films may also be obtained by transfer methods, wherein materials, lacquers, finishes, or laminates of the aforementioned materials or polymer materials are applied to a transfer carrier material. The resulting films are optionally cured, and afterwards stripped from the carrier material in order to be used subsequently in the carbonization or pyrolysis step.

In preparing films on a carrier material, the coating of the carrier material may be performed by suitable printing methods, including but not limited to: anilox-roller printing, knife coating, spray coating, thermal, pressed, or wet-on-wet laminations, and the like. Several thin layers may be applied in order to improve the structure and dimensional accuracy of the polymer film. Furthermore, during the application of coatings onto a transfer carrier material, different gratings may optionally be used to provide a more homogeneous lacquer distribution.

Using transfer methods of the kind described above, it is also possible to produce multilayer graded films with different layer material sequences. Such multilayer films can yield carbon-based graded materials after carbonization wherein, for example, the density of the resulting material may vary depending upon the location.

Very thin polymer films for use in the method according to the invention may be produced on suitable carrier materials by the transfer method by using, for example, powder coating or hot-melt coating and then stripping and carbonizing the films. If the carrier material is to be completely volatilized under carbonization conditions, such as when using polyolefin films, stripping the polymer film from the carrier material may not be necessary or even preferred.

Furthermore, by the transfer method it is also possible to achieve a structuring or microstructuring of the produced polymer films by appropriately pre-structuring the transfer carrier material, e.g. through prior plasma etching. When forming a thin coating of polymer film on a carrier material, the structure of the carrier material may be transferred to the polymer film in this way.

In certain embodiments of the invention, the polymer film may also be applied as a coating to temperature-resistant substrates in order to yield carbon-based, porous layers for use as membranes or molecular layers after pyrolysis or carbonization. The substrate may b emade from, for example, glass, ceramic, metal, metal alloy, metal oxide, silicon oxide, aluminum oxide, zeolite, titanium oxide, zirconium oxide, as well as mixtures of these materials, and it may be pre-formed as desired. One embodiment includes the preparation of adsorber pellets with membrane coatings formed from materials producible according to the invention.

The polymer film used in the method of the present invention may be coated, impregnated, or modified with organic and/or inorganic compounds prior to pyrolysis and/or carbonization. An optional coating applied to one or both sides of the polymer film may comprise, for example, epoxy resins, phenol resin, tar, tar pitch, bitumen, rubber, polychloroprene or poly(styrene-co-butadiene) latex materials, siloxanes, silicates, metal salts or metal salt solutions, for example transition metal salts, carbon black, fullerenes, active carbon powder, carbon molecular sieve, perovskite, aluminum oxides, silicon oxides, silicon carbide, boron nitride, silicon nitride, precious metal powder such as Pt, Pd, Au, or Ag; as well as combinations of the aforementioned materials.

Material produced in accordance with the present invention may also be obtained by superficial parylenization or impregnation of the polymer films or the carbon-based materials obtained therefrom. As an example, the polymer films may be treated initially at a higher temperature, typically about 600° C., with paracyclophane, a layer of poly(p-xylylene) being formed superficially on the polymer films or materials created therefrom. This layer may optionally be converted into carbon in a succeeding carbonization or pyrolysis step.

In other embodiments, the step sequence of parylenization and carbonization may be repeated several times.

The properties of the porous carbon-based material resulting from pyrolysis and/or carbonization may be specifically influenced and improved by using a one- or two-sided coating of the polymer film made from one or more of the materials mentioned above, or through specific incorporation of such materials in the polymer film structure. For example, the thermal expansion coefficient of the resulting carbon material as well as its mechanical properties or porosity properties may be modified by incorporation of layered silicates into the polymer film or by coating of the polymer film with layered silicates, nanoparticles, inorganic nanocomposite metals, metal oxides and the like.

In particular, during the preparation of coated substrates that are provided with a layer of the material prepared according to the invention, it is possible to improve the adherence of the applied layer to the substrate or to adjust the thermal expansion coefficient of the outer layer to better match that of the substrate by the incorporation of the aforementioned additives into the polymer film. The coated substrates may then become more resistant to breaks in and flaking of the membrane layer. Consequently, these materials are substantially more durable and have a higher long-term stability in use than conventional products of this kind.

The chemical and adsorptive properties of the resulting porous carbon-based material may be adjusted or modified by application or the incorporation of metals and metal salts, including precious metals and transition metals. For specific applications, the resulting material may also be provided with heterogeneous catalytic properties or other special properties.

In another embodiment of the method according to the invention, the physical and chemical properties of the porous carbon-based material are further modified after pyrolysis or carbonization through appropriate aftertreatment steps, and are adjusted to the desired applications.

Suitable aftertreatments include, but are not limited to, reducing or oxidative aftertreatment steps, wherein the material is treated with suitable reducing agents and/or oxidizing agents such as hydrogen, carbon dioxide, water vapor, oxygen, air, nitric acid and the like, or optionally mixtures thereof.

The aftertreatment steps may optionally be carried out at a higher temperature, but below the pyrolysis temperature, for example from 40° C. to 1,000° C., preferably 70° C. to 900° C., more preferably 100° C. to 850° C., even more preferably 200° C. to 800° C., and most preferably 700° C. In an embodiment, the material prepared according to the invention is modified reductively or oxidatively, or with a combination of these aftertreatment steps, at room temperature.

Through oxidative or reductive treatment or also through the incorporation of additives, fillers, or functional materials, the surface properties of the materials prepared according to the invention may be specifically influenced or changed. For example, through incorporation of inorganic nanoparticles or nanocomposites such as layered silicates, the surface properties of the material may be hydrophilized or hydrophobized.

Additional suitable additives, fillers, or functional materials to be used with the present invention include silicon or aluminum oxides, aluminosilicates, zirconium oxides, talcum, graphite, carbon black, zeolites, clay materials, phyllosilicates, and the like.

In another embodiment, the adjustment of the porosity may occur through washing out of fillers such as, for example, polyvinylpyrrolidone, polyethylene glycol, aluminum powder, fatty acids, microwaxes or emulsions, paraffins, carbonates, dissolved gases, or water-soluble salts, with water, solvent, acids or bases, or by distillation or oxidative or non-oxidative decomposition. The porosity may optionally also be generated by structuring of the surface with powdery substances including, but not limited to, metal powder, carbon black, phenol resin powder, or fibers, in particular carbon or natural fibers.

The addition of aluminum-based fillers may result in an increase of the thermal expansion coefficient, and addition of glass, graphite, or quartz-based fillers may result in a decrease of the thermal expansion coefficient. Adjustment of the thermal expansion coefficient of the materials made according to the invention thus may be achieved by mixing of such components in the polymer system. A further adjustment of the properties may also be achieved through preparation of a fiber composite by means of addition of carbon, polymer, glass, or other fibers in woven or nonwoven form, which results in a noticeable increase of the elasticity and other mechanical properties of the coating.

The materials prepared according to the invention may also be provided with biocompatible surfaces by later incorporation of suitable additives, and may optionally be used as bioreactors or excipients. For example, drugs or enzymes may be introduced in the material, the former being optionally controllably released through suitable retarding and/or selective permeation properties of the membranes.

In another embodiment the materials prepared according to the invention are fluorinated. The materials according to the invention may be provided with lipophobic properties by using a high degree of fluorination, or with lipophilic properties by using a low degree of fluorination.

In another embodiment the materials prepared according to the invention are at least superficially hydrophilized by treatment with water-soluble substances including, but not limited to, polyvinylpyrrolidone or polyethylene glycols, or polypropylene glycols.

Through these measures described above, the wetting behavior of the materials produced in accordance with the invention may be modified in the desired manner.

In another embodiment the carbonized material may also be subjected to a so-called CVD process (Chemical Vapor Deposition) as an additional optional process step in order to further modify the surfaces or pore structure and their properties. For this optional step, the carbonized material is treated with suitable precursor gases at high temperatures. Such general CVD methods are known in the state of the art.

Almost all known saturated and unsaturated hydrocarbons with sufficient volatility under CVD-conditions are considered as carbon-cleaving precursors. Examples are methane, ethane, ethylene, acetylene, linear and branched alkanes, alkenes, and alkynes with carbon numbers of C₁-C₂₀, aromatic hydrocarbons such as benzene, naphthalene, etc., as well as singly and multiply alkyl, alkenyl, and alkynyl-substituted aromatics such as for example toluene, xylene, cresol, styrene, etc.

BCl₃, NH₃, silanes such as tetraethoxysilane (TEOS), SiH₄, dichlorodimethylsilane (DDS), methyltrichlorosilane (MTS), trichlorosilyldichloroborane (TDADB), hexadichloromethylsilyl oxide (HDMSO), AlCl₃, TiCl₃ or mixtures thereof may be used as ceramics precursors.

Such precursors are mostly used in CVD-methods in small concentrations of about 0.5 to 15 percent by volume with an inert gas, such as for example nitrogen, argon or the like. The addition of hydrogen to appropriate depositing gas mixtures is also possible. At temperatures between 200 and 2,000° C., preferably 500 to 1,500° C., and most preferably 700 to 1,300° C., the mentioned compounds cleave hydrocarbon fragments or carbon or ceramic precursors that deposit essentially uniformly distributed in the pore system of the pyrolyzed material, modify the pore structure there, and that way cause an essentially homogeneous pore size and pore distribution in the sense of a further optimization.

For control of the uniform distribution of the deposited carbon or ceramic particles in the pore system of the carbonized material, for example during the deposition of carbon precursors on a surface of the carbonized object, a pressure gradient, e.g. in form of a continuous negative pressure or vacuum, may be applied, whereby the deposited particles are uniformly sucked into the pore structure of the carbonized substance (so-called “forced flow CVI,” Chemical Vapor Infiltration; see e.g. W. Benzinger et. al., Carbon 1996, 34, page 1465). Furthermore, the homogenization of the pore structure achieved in this manner may increase the mechanical strength of the materials prepared in this manner.

This method may, in an analogous fashion, also be used with ceramic, sintered metal, metal or metal alloy precursors as mentioned above.

In another embodiment, the surface properties of material produced may be further modified by means of ion implantation. Through implantation of nitrogen, nitride, carbonitride, or oxynitride phases with included transition metals may be formed, which may noticeably increase the chemical resistance and mechanical resistivity of the carbon-containing materials. The ion implantation of carbon may be used for increasing the mechanical strength of the material produced as well as for redensification of porous materials.

In other embodiments, the material prepared according to the invention may be mechanically reduced to small pieces after pyrolysis and/or carbonization by means of suitable methods, for example through milling in ball or roller mills and the like. The material prepared in this manner that was reduced to small pieces may be used as powder, flakes, rods, spheres, hollow spheres of different granulation, or may be processed to granulates or extrudates of various form by means of conventional methods of the state of the art. Hot-press methods, optionally with addition of suitable binders, may also be used in order to form the material according to the convention. All polymers that intrinsically possess membrane properties or are appropriately prepared in order to incorporate the materials mentioned above are particularly suitable for this.

In another embodiment, small-sized powder material may also be prepared in accordance with the method according to the invention by reducing the polymer film to small pieces in a suitable manner prior to pyrolysis and/or carbonization.

In preferred embodiments of the method of the present invention, however, the polymer films are suitably structured prior to pyrolysis and/or carbonization. For example, they may be stamped, combined with one another to form structural units, adhesively bonded, or mechanically bonded to one another. The arrangement of such suitably pre-structuring polymer film material, which may be easily formed in a simple manner, can remain essentially unchanged during and after the pyrolysis step.

The pyrolysis or carbonization step of the method according to the invention is typically carried out at temperatures in the range of 80° C. to 3,500° C., preferably at about 200° C. to about 2,500° C., most preferably at about 200° C. to about 1,200° C. Preferred temperatures in some embodiments are at 250° C. to 500° C. The temperature, depending on the properties of the materials used, is preferably chosen in such a way that the polymer film is essentially completely transformed into carbon-containing solid with a temperature expenditure that is as low as possible. Through suitable selection or control of the pyrolysis temperature, the porosity, the strength and the stiffness of the material, and other properties may be adjusted.

The atmosphere during the pyrolysis or carbonization step may be essentially free of oxygen. The use of inert gas atmospheres is preferred. Such inert gas atmospheres may comprise nitrogen, noble gases such as argon and neon, as well as other gases or gaseous compounds that are non-reactive with carbon, or reactive gases such as carbon dioxide, hydrochloric acid, ammonia, hydrogen, and mixtures of inert gases. Nitrogen and/or argon are preferred. In some embodiments activation with the reactive gases, which may also comprise oxygen or water vapor, may occur after carbonization in order to achieve the desired properties.

The pyrolysis and/or carbonization in the method according to the invention is typically carried out at normal pressure in the presence of inert gases as mentioned above. Optionally, however, the use of higher inert gas pressures may also be advantageous. In certain embodiments of the method according to the invention, the pyrolysis and/or carbonization may also occur at negative pressure or under a partial vacuum.

The pyrolysis step may be carried out in a continuous furnace process, wherein the optionally structured, coated, or pretreated polymer films are supplied at one end the furnace and exit the furnace at the other end. In some embodiments, the polymer film or the object formed from polymer films may lie on a perforated plate, a screen or the like so that negative pressure may be applied through the polymer film during pyrolysis and/or carbonization. This not only allows for a simple fixation of the objects in the furnace but also for exhaustion and optimal flowing of the inert gas through the films or structural units during pyrolysis and/or carbonization.

By means of appropriate inert gas locks, the furnace may be subdivided into individual segments, wherein successively one or more pyrolysis or carbonization steps may be carried out, optionally under different pyrolysis or carbonization conditions, such as for example different temperature levels, different inert gases, or different pressures (e.g. a partial vacuum).

Furthermore, in appropriate segments of the furnace, aftertreatment steps such as reactivation through reduction or oxidation or impregnation with metals, metal salt solutions, or catalysts, etc. may also optionally be carried out.

Alternatively, the pyrolysis/carbonization may also be carried out in a closed furnace, when the pyrolysis and/or carbonization is to be carried out under partial vacuum.

During pyrolysis and/or carbonization in the method according to the invention, a decrease in weight of the polymer film typically occurs. This weight decrease may be about 5% to 95%, preferably about 40% to 90%, and more preferably about 50% to 70%, depending upon the starting material and pre-treatment used. Moreover, during pyrolysis and/or carbonization in the method according to the invention, shrinkage of the polymer film or of the structure or structural unit created from polymer films normally occurs. The shrinkage may have a magnitude of 0% to about 95%, preferably about 10% to 30%.

The materials prepared according to the invention tend to be chemically stable, mechanically loadable, electrically conductive, and heat resistant.

In an embodiment of the invention, the electrical conductivity may be adjusted over a wide range, depending upon the pyrolysis or carbonization temperature used and the nature and amount of the additive or filler employed. Thus, using temperatures in the range of 1,000 to 3,500° C., due to the graphitization that may occur in the material, a higher conductivity may be achieved than by using lower temperatures. In addition, the electrical conductivity may also be increased by addition of graphite to the polymer film, which then may be pyrolyzed or carbonized at lower temperatures.

Upon heating in an inert atmosphere from 20° C. to 600° C. and subsequent cooling to 20° C., the materials prepared according to the invention may exhibit a dimensional change of no more than +/−10%, preferably no more than +/−1%, or more preferably no more than +/−0.3%.

The porous carbon-based material prepared according to the invention exhibits, depending upon the starting material, amount and nature of the fillers, a carbon content of at least 1 percent by weight, preferably at least 25 percent by weight, optionally also at least 60 percent by weight und more preferably at least 75 percent by weight. Material that is especially preferred according to the invention has a carbon content of at least 50 percent by weight.

The specific surface according to BET of materials prepared according to the invention is typically very small since the porosity is smaller than is detectable with this method. However, by means of appropriate additives or methods (porosity agent or activation), BET surfaces of over 2,000 m²/g are achievable.

The material prepared in accordance with the method according to the invention in sheet or powder form may be used for the preparation of membranes, adsorbents, and/or membrane modules or membrane packages. The preparation of membrane modules in accordance with the method according to the invention may occur, for example, as described in WO 02/32558, with a polymer film being used instead of the paper base matrix described therein. The disclosures of WO 02/32558 are incorporated herein by reference.

Examples for the use of the material prepared according to the invention in the area of fluid separation include, but are not limited to: general gas separation such as oxygen-nitrogen separation for the accumulation of oxygen from air, separation of hydrocarbon mixtures, isolation of hydrogens from hydrogen-containing gas mixtures, gas filtration, isolation of CO₂ from ambient air, isolation of volatile organic compounds from exhaust gases or ambient air, purification, desalting, softening or recovery of drinking water, fuel cell electrodes, to form Sulzer packages, Raschig rings and the like.

In another embodiment of the present invention, the polymer film may be applied in the form of a surface coating, prior to pyrolysis or carbonization, to conventional adsorber materials or membranes such as activated carbon, zeolite, ceramics, sintered metals, papers, wovens, nonwovens, metals, or metal alloys and the like, preferably to adsorber materials having the form of pellets or granules.

After pyrolysis or carbonization, adsorber materials may be prepared with a superficial membrane layer, whereby the selectivity of the adsorbers is determined by the selectivity of the membrane. In this manner, for example, adsorber granulates may be prepared that selectively adsorb only those substances that are able to permeate through the membrane. A quick exhaustion of the adsorber due to covering with undesirable accessory components is thereby protracted or avoided. Thus the exchange intervals of adsorber cartridges containing such materials may be prolonged in appropriate applications, which leads to an increased cost effectiveness.

Applications of such membrane-coated adsorbers may include PSA systems, automotive or airplane cabins, breathing protection systems such as gas masks, and the like.

The invention will now be further described by way of the following non-limiting examples.

### EXAMPLE 1

Pyrolysis and carbonization of cellulose acetate film coated thinly on both sides with nitrocellulose, manufacturer UCB Films, type Cellophane® MS 500, total thickness 34.7 microns, 50 g/m².

The film was pyrolyzed or carbonized at 830° C. in purified nitrogen atmosphere (flow rate of 10 liter/min.) over a period of time of 48 hours in a commercial high-temperature furnace. Subsequently, the shrinkage occurring thereby was determined by comparison of the averaged measured values of each of three rectangular film pieces and the carbon sheets prepared therefrom. The results are compiled in Table 1.

TABLE 1
Shrinkage of the nitrocellulose-coated film

| | Priot to | After | difference |
|---|---|---|---|
| Cellophane ® MS 500 | pyrolysis | pyrolysis | [%] |
| Length a [mm] | 120 | 70 | 41.7 |
| Length b [mm] | 60 | 44 | 26.7 |
| Area [mm²] | 7,200 | 3,080 | 57.2 |
| Weight [g] | 0.369 | 0.075 | 79.7 |

Subsequently, the nitrogen and hydrogen permeability of the carbon sheets prepared above was tested under different conditions. The conditions and results are listed below in Table 2. The permeability values are average values from three measurements each.

TABLE 2
Membrane data:

| | Temperature | Pressure | | Membrane | Permeability |
|---|---|---|---|---|---|
| Gas | [° C.] | [bar] | Time [sec] | area [m²] | [l/m²*h*bar] |
| N₂ | 25 | 0.10 | Not measurable | 0.000798 | — |
| N₂ | 25 | 0.20 | Not measurable | 0.000798 | — |
| N₂ | 25 | 0.50 | Not measurable | 0.000798 | — |
| N₂ | 25 | 1.00 | Not measurable | 0.000798 | — |
| H₂ | 25 | 0.20 | 69.0 | 0.000798 | 33 |
| H₂ | 25 | 0.30 | 60.0 | 0.000798 | 25 |
| H₂ | 25 | 0.40 | 58.0 | 0.000798 | 19 |
| H₂ | 25 | 0.50 | 58.0 | 0.000798 | 16 |
| H₂ | 25 | 0.99 | 39.1 | 0.000798 | 12 |
| H₂ | 25 | 2.00 | 24.9 | 0.000798 | 9 |
| H₂ | 25 | 2.5 | Torn | 0.000798 | — |

### EXAMPLE 2

Pyrolysis and carbonization of cellulose acetate films coated thinly on both sides with polyvinylidene chloride (PVdC), manufacturer UCB Films, type Cellophane® XS 500, total thickness 34.7 microns, 50 g/m².

The film was pyrolyzed or carbonized at 830° C. in purified nitrogen atmosphere (flow rate of 10 liter/min.) over a period of time of 48 hours in a commercial high-temperature furnace. Subsequently, the shrinkage occurring thereby was determined by comparison of the averaged measured values of each of three rectangular film pieces and the carbon sheets prepared therefrom. The results are compiled in Table 3.

TABLE 3
Shrinkage of the PVdC-coated film

| | Priot to | After | Difference |
|---|---|---|---|
| Cellophane ® XS 500 | pyrolysis | pyrolysis | [%] |
| Length a [mm] | 120 | 67 | 44.2 |
| Length b [mm] | 60 | 41 | 31.7 |
| Area [mm²] | 7,200 | 2,747 | 61.9 |
| Weight [g] | 0.377 | 0.076 | 79.8 |

### EXAMPLE 3

Pyrolysis and carbonization of homogeneous and defect-free epoxy resin films, total thickness 7 microns prior to carbonization, 2.3 microns after carbonization.

The film was prepared by a solvent evaporation method from a 20 percent by weight solution.

The carbonization occurred at 830° C. in a purified nitrogen atmosphere (flow rate of 10 liter/min.) over a period of time of 48 hours in a commercial high-temperature furnace. Subsequently, the shrinkage occurring thereby was determined by comparison of the averaged measured values of each of three rectangular film pieces and the carbon sheets prepared therefrom. The results are compiled in Table 4.

TABLE 4
Shrinkage of the epoxy film

| | Prior to | After | Difference |
|---|---|---|---|
| | pyrolysis | pyrolysis | [%] |
| Length a [mm] | 100 | 46 | 54 |
| Length b [mm] | 100 | 44 | 56 |
| Area [mm²] | 10,000 | 2,024 | 78 |
| Weight [g] | 0.0783 | 0.0235 | 70 |

The sheet material prepared in this manner was:
a) In a second activation step subjected to a second temperature treatment in air at 350° C. for 2 hours.
b) In a second step provided with a hydrocarbon CVD layer, carried out at 700° C. in a second temperature treatment.

Thereby, the water-absorption capacity changed. It was measured as follows: 1 mL VE water was placed on the film surface with a pipette (20 mm diameter each) and allowed to act for 5 minutes. Afterwards, the weight difference was determined. Results are shown below.

Water Absorption [g]

| | |
|---|---|
| Carbonized sample | 0.0031 |
| a) Activated sample | 0.0072 |
| b) CVD-modified sample | 0.0026. |

It can be seen from the results above that the CVD modification reduces the porosity of the sheet material, whereas the activation increases the porosity of the sheet material.

### EXAMPLE 4

Pyrolysis and carbonization of homogeneous and defect-free expoxy resin films, total thickness 3 g/m².

The film was prepared by a solvent evaporation method from a 15 percent by weight epoxy coating solution to which was added 50% of a polyethylene glycol (based on epoxy resin lacquer, Mw 1,000 g/mol) in a dip coating method on stainless steel substrates with a 25 mm diameter.

The carbonization occurred at 500° C. in a purified nitrogen atmosphere (flow rate of 10 liter/min.) over a period of time of 8 hours in a commercial high-temperature furnace.

Subsequently, the coating was washed out at 60° C. for 30 minutes in an ultrasound bath in water and weighed.

TABLE 5
Weight changes during processing

| | |
|---|---|
| Weight of round plate without coating: | 1.2046 g |
| Weight after coating | 1.2066 g |
| Weight after carbonization | 1.2061 g |
| Weight after washing-out procedure | 1.2054 g. |

These results indicate that the porosity of the films can be increased by the washing-out procedure.

The invention is further described by the following numbered paragraphs:
1. Method for the preparation of porous carbon-based material, comprising the following steps:
   a) provision of a polymer film in the form of a sheet or a coating;
   b) pyrolysis and/or carbonization of the polymer film in an atmosphere that is essentially free of oxygen at temperatures in the range of 80° C. to 3,500° C.
2. Method according to numbered paragraph 1, characterized in that the polymer film is structured prior to pyrolysis and/or carbonization by stamping, folding, die-cutting, printing, extruding, combinations thereof and the like.
3. Method according to numbered paragraph 1 or numbered paragraph 2, characterized in that the polymer film comprises films of homo or copolymers of aliphatic or aromatic polyolefins such as polyethylene, polypropylene, polybutene, polyisobutene, polypentene, polybutadiene, polyvinyls such as polyvinyl chloride or polyvinyl alcohol, poly(meth)acrylic acid, polyacrylonitrile, polyamide, polyester, polyurethane, polystyrene, polytetrafluorethylene, mixtures and combinations of these homo or copolymers.
4. Method according to numbered paragraph 1 or numbered paragraph 2, characterized in that the polymer film is a coating selected from lacquer, laminate, or finish.
5. Method according to numbered paragraph 4, characterized in that the polymer film is a lacquer film prepared from a lacquer with a binder base of alkyd resin, chlorinated rubber, epoxy resin, acrylate resin, phenol resin, amine resin, oil base, nitro base, polyester, polyurethane, phenol resin, tar, tar-like materials, tar pitch, bitumen, starch, cellulose, shellac, organic materials from renewable raw materials, or combinations thereof.
6. Method according to any of the previous numbered paragraphs, characterized in that the polymer film comprises inorganic additives or fillers.
7. Method according to numbered paragraph 6, characterized in that the inorganic additives or fillers are selected from silicon or aluminum oxides, aluminosilicates, zirconium oxides, talcum, graphite, carbon black, zeolites, clay materials, phyllosilicates, wax, paraffin, salts, metals, metal compounds, soluble organic compounds such as e.g. polyvinylpyrrolidone or polyethylene glycol and the like.
8. Method according to numbered paragraph 6 or numbered paragraph 7, characterized in that the fillers are removed from the matrix by washing out with water, solvent, acids, or bases, or by oxidative or non-oxidative thermal decomposition.
9. Method according to any of numbered paragraphs 6 to 8, characterized in that the fillers are present in form of powders, fibers, wovens, nonwovens.
10. Method according to any of numbered paragraphs 6 to 9, characterized in that the fillers are suitable to cause foam formation in or on the polymer film.
11. Method according to any of the previous numbered paragraphs, characterized in that the material is subjected to an oxidative and/or reducing aftertreatment subsequent to pyrolysis and/or carbonization.
12. Porous, carbon-based material that is producible in accordance with the method according to any of the previous numbered paragraphs.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A method for the preparation of porous carbon-based material, comprising the following steps:
a) provision of a polymer film in the form of a sheet or a coating;
b) pyrolysis and/or carbonization of the polymer film in an atmosphere that is essentially free of oxygen at a temperature between 80° C. and 3500° C.;
c) aftertreatment of the material in a reducing or oxidizing atmosphere at a temperature that is lower than the temperature used for pyrolysis and/or carbonization.

2. The method of claim 1 wherein the pyrolysis and/or carbonization step is carried out at a temperature between 200° C. and 2500° C.

3. The method of claim 1 wherein the pyrolysis and/or carbonization step is carried out at a temperature between 200° C. and 1200° C.

4. The method of claim 1 wherein the pyrolysis and/or carbonization step is carried out at a temperature between 250° C. and 500° C.

5. The method according to claim 1, wherein the aftertreatment is carried out at room temperature.

6. The method according to claim 1 wherein the polymer film is structured prior to pyrolysis and/or carbonization by stamping, folding, die-cutting, printing, extruding, or a combination thereof.

7. The method according to claim 1 wherein the polymer film comprises a film of homo- or copolymers of aliphatic or aromatic polyolefins such as polyethylene, polypropylene, polybutene, polyisobutene, polypentene, polybutadiene, polyvinyls such as polyvinyl chloride or polyvinyl alcohol, poly(meth)acrylic acid, polyacrylonitrile, polyamide, polyester, polyurethane, polystyrene, polytetrafluorethylene, or mixtures and combinations of these homo- or copolymers.

8. The method according to claim 1 wherein the polymer film comprises a coating selected from lacquer, laminate, or finish.

9. The method according to claim 1 wherein the polymer film comprises a lacquer coating prepared from a lacquer with a binder base of alkyd resin, chlorinated rubber, epoxy resin, acrylate resin, phenol resin, amine resin, oil base, nitro base, polyester, polyurethane, phenol resin, tar, tar-like materials, tar pitch, bitumen, starch, cellulose, shellac, organic materials from renewable raw materials, or any combination thereof.

10. The method according to claim 1 wherein the polymer film further comprises inorganic additives or fillers.

11. The method according to claim 10 wherein the inorganic additives or fillers are selected from the group consisting of silicon or aluminum oxides, aluminosilicates, zirconium oxides, talcum, graphite, carbon black, zeolites, clay materials, phyllosilicates, wax, paraffin, salts, metals, metal compounds, and soluble organic compounds such as polyvinylpyrrolidone and polyethylene glycol.

12. The method according to claim 10 further comprising the step of removing the fillers from the matrix by washing out with water, solvent, acids, or bases, or by oxidative or non-oxidative thermal decomposition.

13. The method according to claim 10 wherein the fillers are present in the form of powders, fibers, or woven materials.

14. The method according to claim 10 wherein the fillers are suitable to cause foam formation in or on the polymer film.

15. The method according to claim 1 wherein the polymer film comprises a polymer foam system.

16. The method according to claim 1 further comprising the step of subjecting the porous carbon-based material to a CVD process.

17. The method according to claim 1 wherein the polymer film comprises a coating applied to a conventional adsorber material or membrane.

18. A porous, carbon-based material that is producible in accordance with the method of claim 1.
